(19) United States
(12) Patent Application Publication
(10) Pub. No.: US 2015/0139368 A1
(43) Pub. Date: May 21, 2015

(54) ENHANCED CHANNEL ESTIMATION IN TD-SCDMA

(71) Applicant: QUALCOMM Incorporated, San Diego, CA (US)

(72) Inventors: Farrokh ABRISHAMKAR, San Diego, CA (US); Venkata Gautham Chavali, Hyderabad (IN); Insung Kang, San Diego, CA (US); Bahadir Canpolat, Fleet (GB)

(73) Assignee: QUALCOMM Incorporated, San Diego, CA (US)

(21) Appl. No.: 14/082,884

(22) Filed: Nov. 18, 2013

(51) Int. Cl. H04L 25/02

(52) U.S. Cl. CPC H04L 25/025
USPC 375/346

(57) ABSTRACT

Apparatus and methods for channel estimation in time division synchronous code division multiple access (TD-SCDMA) based on a signal received from one or more Node Bs include determining least squares channel metric estimates based on the received signal, identifying signal taps and noise taps in a tapped delay line channel estimate based on at least one of temporal correlations of the least squares channel metric estimates or composite hypothesis testing on the least squares channel metric estimates, and updating an interference buffer based on the signal taps and the noise taps.

### REFERENCE TO CO-PENDING APPLICATIONS FOR PATENT

The present application for Patent is related to the following co-pending U.S. patent applications:
“METHOD AND APPARATUS FOR ENHANCED CHANNEL ESTIMATION USING MATCHING PURSUIT,” having Attorney Docket No. 133064, filed concurrently herewith, assigned to the assignee hereof, and expressly incorporated by reference herein; and
“METHOD AND APPARATUS FOR ENHANCED CHANNEL ESTIMATION USING MATCHING PURSUIT AND ADAPTIVE CLUSTER TRACKING,” having Attorney Docket No. 133065, filed concurrently herewith, assigned to the assignee hereof, and expressly incorporated by reference herein.

### BACKGROUND

Aspects of the present disclosure relate generally to wireless communication systems, and more particularly, to apparatus and methods for enhanced channel estimation in Time Division Synchronous Code Division Multiple Access (TD-SCDMA).

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

For mobile devices that receive signals according to Time Division Synchronous Code Division Multiple Access (TD-SCDMA), accurate channel estimation is required for ensuring acceptable receiver performance, as channel estimation impacts, for example, demodulation, decode cell reselection, and TD-SCDMA protocol processing. Conventionally, channel estimation in TD-SCDMA includes linear least-squares followed by cleaning or tap identification.

As the demand for mobile broadband access continues to increase, research and development continue to advance the UMTS technologies not only to meet the growing demand for mobile broadband access, but to advance and enhance the user experience with mobile communications. Thus, in this case, improved apparatus and methods are desired for enhanced channel estimation in TD-SCDMA.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one aspect, a method for channel estimation in time division synchronous code division multiple access (TD-SCDMA) based on a signal received from one or more Node Bs is provided that includes determining least squares channel metric estimates based on the received signal, identifying signal taps and noise taps in a tapped delay line channel estimate based on at least one of temporal correlations of the least squares channel metric estimates or composite hypothesis testing on the least squares channel metric estimates, and updating an interference buffer based on the signal taps and the noise taps.

In another aspect, an apparatus for channel estimation in TD-SCDMA based on a signal received from one or more Node Bs is provided that includes a processing system configured to determine least squares channel metric estimates based on the received signal, identify signal taps and noise taps in a tapped delay line channel estimate based on at least one of temporal correlations of the least squares channel metric estimates or composite hypothesis testing on the least squares channel metric estimates, and update an interference buffer based on the signal taps and the noise taps.

In a further aspect, a computer program product for channel estimation in TD-SCDMA based on a signal received from one or more Node Bs is provided that includes a computer-readable medium including code for determining least squares channel metric estimates based on the received signal, code for identifying signal taps and noise taps in a tapped delay line channel estimate based on at least one of temporal correlations of the least squares channel metric estimates or composite hypothesis testing on the least squares channel metric estimates, and code for updating an interference buffer based on the signal taps and the noise taps.

These and other aspects of the present disclosure will become more fully understood upon a review of the detailed description, which follows.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic block diagram of one aspect of a system for enhanced channel estimation in TD-SCDMA;

FIG. 2 is a block diagram illustrating a prior art example of channel estimation in aspects of the system of FIG. 1;

FIG. 3 is a block diagram illustrating an example of a first channel estimation aspect in the system of FIG. 1;

FIG. 4 is an example graph illustrating hypothesis testing in aspects of the system of FIG. 1;

FIGS. 5 and 6 are block diagrams illustrating further examples of channel estimation aspects in the system of FIG. 1;

FIG. 7 is a flowchart of an aspect of the methods of the system of FIG. 1;

FIG. 8 is a block diagram illustrating an example of a hardware implementation for an apparatus of FIG. 1 employing a processing system;

FIG. 9 is a block diagram conceptually illustrating an example of a telecommunications system including aspects of the system of FIG. 1;

FIG. 10 is a conceptual diagram illustrating an example of an access network including aspects of the system of FIG. 1; and

FIG. 11 is a block diagram conceptually illustrating an example of a Node B in communication with a UE in a telecommunications system including aspects of the system of FIG. 1.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Aspects of the present disclosure provide methods and apparatus for enhanced channel estimation in Time Division Synchronous Code Division Multiple Access (TD-SCDMA). In some aspects, the equivalent channel of a target Walsh code is estimated. In some further aspects, for example, for multiuser detection and/or interference cancellation, the equivalent channel of each active Walsh code is also estimated since, for example, the quality of the channel estimate of the target Walsh code depends on the quality of the channel estimation for the other Walsh codes. In some aspects, channel estimation is enhanced at a user equipment (UE) operating in TD-SCDMA by using the spatial and/or temporal properties of the signal and the pulse shape that is used for transmitting the symbols, and perfuming one or more of power time-filtering, ordered composite hypothesis testing, channel tap temporal correlation, or pulse de-convolution, or performing a combining logic to combine any of these aspects.

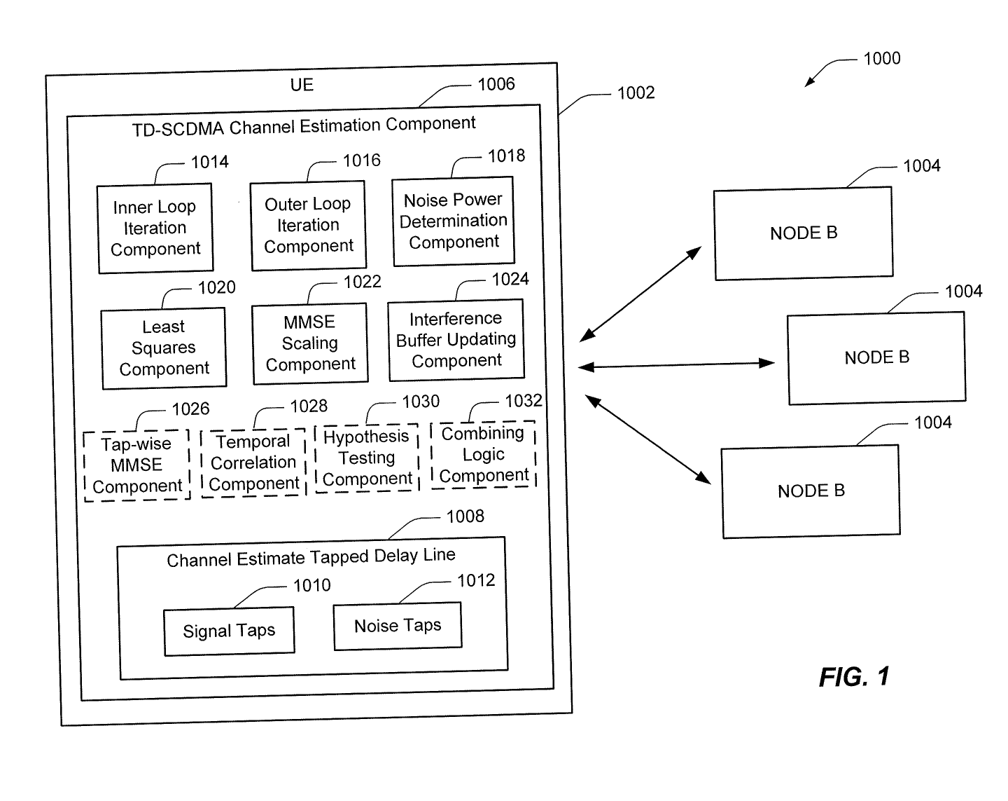

Referring to FIG. 1, in one aspect, system 1000 includes UE 1002 that is communicating with one or more Node Bs 1004 in TD-SCDMA to estimate the downlink channel between Node Bs 1004 and UE 1002 based on the signals received from Node Bs 1004. UE 1002 includes TD-SCDMA channel estimation component 1006 that models the downlink TD-SCDMA channel from Node Bs 1004 as a tapped delay line, and estimates the channel by determining a channel estimate tapped delay line 1008 that includes signal taps 1010 and noise taps 1012, where signals taps 1010 correspond to the non-zero tap identifiers (IDs) within the channel estimate tapped delay line 1008. Conventionally, in TD-SCDMA, the chip rate is 1.28 Mcps and the downlink time slot is 675 us or 874 chips. Table 1 shows an example configuration of chips in a TD-SCDMA downlink time slot.

TABLE 1
An example configuration of chips in a TD-SCDMA downlink time slot

| | | | |
|---|---|---|---|
| Data (352 chips) | Midamble (144 chips) | Data (352 chips) | GP (16 chips) |

As shown in Table 1, there are 144 chips in the midamble of a TD-SCDMA downlink time slot. The midambles are training sequences for channel estimation and power measurements at UE 1002. Each midamble can potentially have its own beamforming weights. Also, there is no offset between the power of the midamble and the total power of all associated channelization codes. The TD-SCDMA downlink time slot further includes 704 data chips and 16 guard period (GP) chips. The midambles (of length Lₘ=144) used by different users in one cell in one time slot are cyclic shifted versions of one of the 128 basic midambles (of length P=128). The number of cyclic shifts per cell may be J=2, 4, 6, 8, 10, 12, 14, 16 (TS0 always uses J=8), and the midambles are generated by rotating a basic midamble, cyclic extending, and sampling. The midamble allocation scheme for uplink and downlink may be, for example, a default, a specific default, a UE specific, or a common.

Conventionally, in TD-SCDMA, transmit data chips for user k in data state and with a spreading factor N=16 may be modeled as:

$$\begin{matrix}{u}_{k} ( n ) = s ( n mod N ) {w}_{k} ( n mod N ) {β}_{k} {d}_{k} ( ⌊ \frac{n}{N} ⌋ ) \\ = {p}_{k} ( n mod N ) {d}_{k} ( ⌊ \frac{n}{N} ⌋ )\end{matrix}$$

where uₖ is the transmit chip for Walsh k (data chip or midamble, i.e., burst k), n is the chip index, s is the cell-specific scramble code, wₖ Walsh code k, βₖ is the channel code multiplier for Walsh k, dₖ is the data symbol for Wash k, and pₖ is the product of k-th Walsh multiplier, Walsh code, and scrambling code. Also, the transmitted data chips at the i-th antenna tⁱ are:

$${t}^{i} ( n ) = {\sum }_{k = 1}^{K} {α}_{k}^{i} {g}_{k } {u}_{k ( n )}$$

$$i = 1 , … , {N}_{t}$$

where Nₜ is the number of transmit antennas, K is the number of active Walsh codes, αₖⁱ is the beamforming weight of Walsh k at the i-th transmit antenna (∥αₖ∥=1), and gₖ is the gain of Walsh k. Further, assuming that there is only one receive antenna at UE 1002, the received signal r (n) at chip index n is:

$$r ( n ) = {\sum }_{i}^{{N}_{t}} {\sum }_{l = 0}^{v} {h}^{i} ( l ) {t}^{i} ( n - l ) + v ( n )$$

where v is the channel memory, is the channel seen by the i-th antenna, and v(n) is additive white Gaussian noise (AWGN). The received signal may be re-written as:

$$\begin{matrix}r ( n ) = {\sum }_{i}^{{N}_{t}} {\sum }_{l = 0}^{v} {h}^{i} ( l ) {\sum }_{k = 1}^{K} {α}_{k}^{i} {g}_{k } {u}_{k } ( n - l ) + v ( n ) \\ = {\sum }_{k = 1}^{K} {\sum }_{l = 0}^{v} {\tilde{h}}_{k} ( l ) {u}_{k} ( n - l ) + v ( n )\end{matrix}$$

where the equivalent channel of the k-th user (after subsuming gain, beamforming, and propagation channel) is defined as:

$${\tilde{h}}_{k} ( l ) = {g}_{k} {\sum }_{i}^{{N}_{t}} {α}_{k}^{i} {h}^{i} ( l )$$

Assuming that the association between the Walsh codes and the midamble shifts is known, and the Walsh codes sharing the same midamble have the same beamforming and same gain, e.g., the Walsh codes using the same midamble have identical equivalent channels, the received signal model at midamble state is:

$$\begin{matrix}r ( n ) = {\sum }_{k = 1}^{K} {\sum }_{l = 0}^{v} {\tilde{h}}_{k} ( l ) {u}_{k} ( n - l ) + v ( n ) \\ = {\sum }_{j = 1}^{J} {\sum }_{l = 0}^{v} {\tilde{h}}_{j}^{c} ( l ) {m}_{j} ( n - l ) + v ( n )\end{matrix}$$

where mⱼ is the j-th midamble (e.g., shift) in the cell, J is the total of midamble shifts, Sⱼ is the set of Walsh indices that map to midamble j, and the equivalent channel seen by j-th midamble is:

$${\tilde{h}}_{j}^{c} ( l ) = {\sum }_{k ∈ {S}_{j}}^{ } {\tilde{h}}_{k} ( l )$$

As such, the equivalent channel seen by the k-th Walsh is:

$${\tilde{h}}_{k} ( l ) = \frac{1}{{S}_{j}} {\tilde{h}}_{j}^{c} ( l ) , \\ ∀ k ∈ {S}_{j}$$

where |S| is the cardinality of set S. Accordingly, the multi-cell signal model of the time domain received midamble sequence of M cells at UE 1002 is:

$$\underline{y} = {\sum }_{i = 1}^{M} {M}_{i} {\tilde{\underline{h}}}_{i}^{c} + \underline{w}$$

$$\underline{{\tilde{h}}_{i}^{c}} = {[ {\underline{h}}_{i 0}^{c T} , {\underline{h}}_{i 1}^{c T} , … , {\underline{h}}_{i K - 1}^{c T} ]}^{T}$$

where y is the 128×1 vector of received midambles that is delayed such that the resulted channel impulse responses (CIRs) are double-sided and centered in the middle, Mⱼ is the 128×128 circulant training matrix of the i-th cell, \tilde{h}^{c}₁ₖ is the equivalent channel for the k^{th} shift and i^{th} cell, and w is a 128×1 complex AWGN with zero mean and E(ww*)=N₀ I.

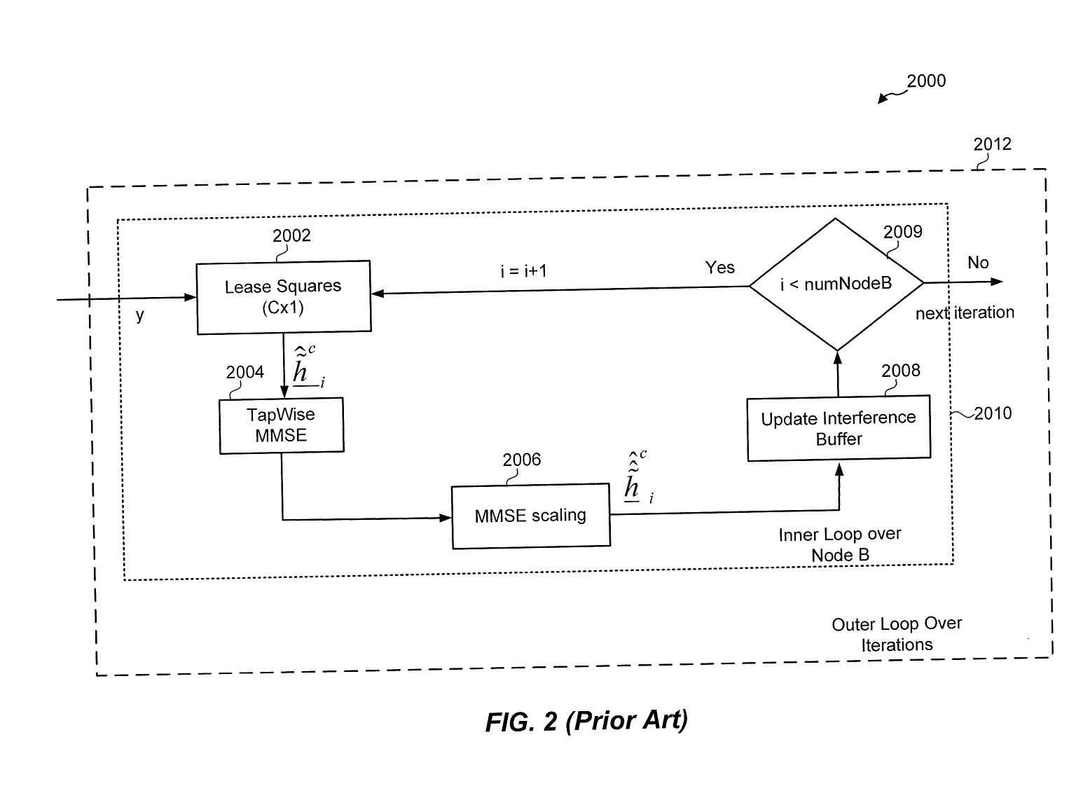

Referring back to FIG. 1, some aspects of FIG. 1 are now described with reference to an example of a conventional channel estimation method 2000 at UE 1002 in TD-SCDMA that is illustrated in the block diagram of FIG. 2 and may be executed by TD-SCDMA channel estimation component 1006 of UE 1002. The conventional channel estimation method 2000 includes an inner loop 2010 over Node Bs 1004 and an outer loop 2012 to iterate the inner loop 2010. The inner loop 2010 and the outer loop 2012 may be, respectively, executed by the inner loop iteration component 1014 and the outer loop iteration component 1016 of TD-SCDMA channel estimation component 1006. Within the inner loop 2010, least squares 2002 is performed on a received signal y to estimate the tap values in the channel estimate tapped delay line 1008. Least squares may be performed by the least squares component 1020 of TD-SCDMA channel estimation component 1006. Then, tap-wise MMSE 2004 (which may be performed by tap-wise MMSE component 1026 of TD-SCDMA channel estimation component 1006) and minimum mean square error (MMSE) scaling 2006 (which may be performed by MMSE scaling component 1022 of TD-SCDMA channel estimation component 1006) are performed on the results of the least squares 2002. In some aspects, for example, tap-wise MMSE 2004 (which may be performed by tap-wise MMSE component 1026) can include the dismissal of a tap if its power is below a combining factor times the noise power. In some aspects, for example, MMSE scaling 2006 (which may be performed by MMSE scaling component 1022) can be based on the following MMSE scaling:

$${{\hat{\tilde{h}}}^{⋒}}_{j}^{c} = \{ \begin{matrix}( \frac{{\vert {\hat{\tilde{h}}}_{j}^{c} \vert}^{2} - {\hat{σ}}_{v}^{2}}{{\vert {\hat{\tilde{h}}}_{j}^{c} \vert}^{2}} ) {\hat{\tilde{h}}}_{j}^{c} & if {\vert {\hat{\tilde{h}}}_{j}^{c} \vert}^{2} > {\hat{σ}}_{v}^{2} \\ 0 & else\end{matrix}$$

Accordingly, in these aspects, the identified and scaled taps provide the channel estimate for a respective Node B. Then, also within the inner loop 2010 and at each inner loop iteration, an interference buffer (which holds the most recent estimates of the channels for the cells or Node Bs 1004) is updated 2008 by interference buffer updating component 1024 according to the identified and scaled taps of the respective Node B 1004 in that iteration of the inner loop 2010, and then the inner loop 2010 repeats if there are more Node Bs 1004 left to be iterated over 2009. The set of inner loops 2010 (e.g., one inner loop 2010 per cell or Node B 1004) is then repeated in the outer loop 2012. The number of outer loop iterations may be, in one non-limiting example, five iterations. At each iteration of the outer loop 2012, the inner loop iteration component 1014 may use the interference buffer 2008 from the previous execution of the inner loop 2010 to update input y by subtracting an estimated inter-cell interference from input y. Such updating of input y may be referred to as Successive Interference Cancellation (SIC). Accordingly, an improved input y (after performing SIC) is provided to the next iteration of the inner loop 2010.

In some present aspects, however, channel estimation is enhanced at UE 1002 by alternatively or additionally using the spatial and/or temporal properties of the signal and the pulse shape that is used for transmitting the symbols, and performing one or more of power time-filtering, ordered composite hypothesis testing, channel tap temporal correlation, pulse de-convolution, or a combining logic to combine any of these aspects.

In some aspects, for example, channel estimation is enhanced at UE 1002 by identifying a number of non-zero tap positions based on the temporal correlation of the taps. For example, in an aspect, TD-SCDMA channel estimation component 1006 may include temporal correlation component 1028 that identifies a number of non-zero tap positions based on the temporal correlation of the taps. Generally, the fading wireless channel is correlated in time while the noise is uncorrelated. As such, in these aspects, the correlation properties of the fading wireless channel and the noise over time are used to identify a set of tap positions that are present (e.g., tap positions that are non-zero). For example, if it is assumed that there are 128 possible taps, the present aspects may be used to narrow this number to identify a set of non-zero tap positions.

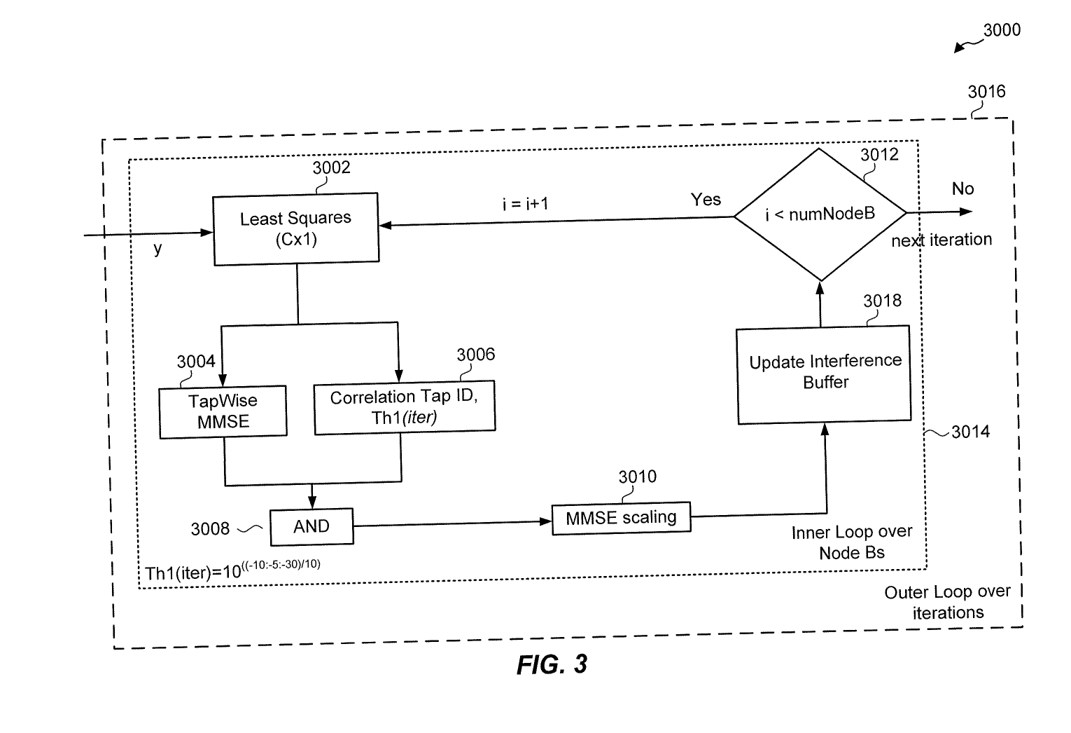

FIG. 3 is one example block diagram of a first channel estimation method 3000 that is based on the temporal correlation of the taps and may be executed by TD-SCDMA channel estimation component 1006 or respective components thereof. The first channel estimation method 3000 includes an inner loop 3014 over Node Bs 1004 executed by the inner loop iteration component 1014, and an outer loop 3016 to iterate the inner loop 3014 (e.g., 5 iterations), executed by the outer loop iteration component 1016. Within the inner loop 3014, least squares 3002 is performed by the least squares component 1020 on a received signal y to estimate the tap values in the channel estimate tapped delay line 1008. Then, TD-SCDMA channel estimation component 1006 performs tap identification by combining tap-wise MMSE 3004 (executed by tap-wise MMSE component 1026) and temporal correlation 3006 (executed by temporal correlation component 1028).

In order to perform tap identification based on tap-wise MMSE 3004, noise power is estimated by noise power determination component 1018 by collecting a number of taps, e.g., at least 48 taps, and computing their average. Then, tap-wise MMSE component 1026 declares a tap as alive if the tap power is greater than a combining factor times the estimated noise power.

In order to perform tap identification based on temporal correlation 3006, temporal correlation component 1028 determines the correlation of the estimated channel taps over time, and identifies the tap as noise if this correlation is close to zero, and identifies the tap as an active tap if this correlation is relatively large. For example, temporal correlation component 1028 may compute a tap correlation across time as:

Rₕ(i,n)=αRₕ(i,n−1)+(1−α)h(i,n)h*(i,n−1)

where Rₕ(i,n) is the temporal correlation of the tap ID with tap index i at time index n, h(i,n) is the tap ID with tap index i at time index n, and α is a constant which may be, in one example aspect, equal to 0.005. In some aspects, the value chosen for α may depend on the variation speed of the channel that is being estimated. A tap may be declared as alive or dead based on:

$$\frac{\vert {R}_{h} ( i , n ) \vert}{{max}_{i} \vert {R}_{h} ( i , n ) \vert} {{0}_{}}^{1} Th ( iter )$$

where Th(iter) is a noise tap threshold value at iteration iter, and tap index i is declared as a signal tap when the left side of the above equation is greater that Th(iter), and as a noise tap when the left side of the above equation is less than Th(iter). In some aspects, for example, increasing the noise tap threshold value in an iteration causes more taps to be cleaned in that iteration, e.g., declaring more taps as noise in that iteration. Similarly, in some aspects, for example, reducing the noise tap threshold valyue in an iteration causes fewer taps to be cleaned in that iteration, e.g., declaring fewer taps as noise in that iteration.

In order to combine 3008 tap-wise MMSE 3004 and temporal correlation 3006, tap-wise MMSE component 1026 may determine a first set of taps and temporal correlation component 1028 may determine a second set of taps. Once a set of tap-wise MMSE taps and a set of temporally correlated taps are identified, TD-SCDMA channel estimation component 1006 classifies a tap as a signal tap if both sets agree 3008 in that tap position, and otherwise declares the tap as an erasure. Also, noise power estimation component 1018 estimates the noise power as the mean power of the resulting identified noise taps, and such noise power estimate may be used, for example, by MMSE scaling component 1022, tap-wise MMSE component 1026, and/or any other receiver components of UE 1002 that perform other operations which may or may not be related to channel estimation. Then, MMSE scaling component 1022 performs MMSE scaling 3010 on the identified taps, and interference buffer updating component 1024 updates an interference buffer 3018 according to the identified and scaled taps of the cell or Node B 1004. The inner loop iteration component 1014 repeats the inner loop 3014 if there are more Node Bs 1004 left to be iterated over 3012. Once the inner loop 3014 has iterated over all Node Bs 1004, outer loop iteration component repeats the set of inner loops 3014 in the outer loop 3016 in a similar manner as described herein with regards to corresponding inner and outer loops in FIG. 2.

Some present aspects may alternatively or additionally include pulse deconvolution to determine an amplitude aspect of channel estimation. More particularly, for each identified tap position, TD-SCDMA channel estimation component 1006 may determine an amplitude of the signal at that tap. After the pulse deconvolution process, TD-SCDMA channel estimation component 1006 may reconstruct the original channel signal (e.g., deconvolved) by, for example, combining the identified tap positions (e.g., the second set of tap positions) and the amplitudes determined for each identified tap position.

In some present aspects, additionally or alternatively, TD-SCDMA channel estimation component 1006 may include hypothesis testing component 1030 that uses hypothesis testing for tap identification. For example, in an aspect, the received signal may be modeled as:

$$\begin{matrix}y = {\sum }_{l}^{ } {M}_{l} {x}_{l} + n \\ = {M}_{1} {x}_{1} + ( {M}_{2} {x}_{2} + {M}_{3} {x}_{3} ) + n \\ = {M}_{1} {x}_{1} + {I}_{1} + n\end{matrix}$$

where y is the vector of 128×1 received chips in the midamble state, M₁ is the 128×128 aggregate circulant midamble matrix for cell 1 (8 shifts, each 128×16), x₁ is the aggregate channel vector for all shifts (8 shifts, each of length 16), 1 is the cell index (l=1 denotes the serving cell), I₁ is the interference to the l^{th} serving cell, and n is thermal noise. In one aspect, a model for successive ordered composite hypothesis test for tap identification (SO-CHI) is developed in two stages of target channel modeling and target tap modeling in the target midamble subspace, in which the received signal may be modeled as:

y=M₁₁x₁₁+I₁₁+n

where x₁₁ is the 16×1 target channel, M₁₁ is the 128×16 target midamble matrix, and I₁ is the 128×1 aggregate interference vector on the target channel. Accordingly, in the target tap model, two hypotheses H1 and H0 for SO-CHI may be defined as:

H1: y=M₁₁a+M₁₁b+I₁₁+n

H0: y=M₁₁b+I₁₁+n

where a is a 16×1 zero vector with only the target tap non-zero element, b is the 16×1 target channel with the target tap set to zero, and hence a+b=x₁₁. Then, the decision rule for tap identification is the following likelihood ratio:

$$Λ = \frac{p ( y \vert H 1 )}{p ( y \vert H 0 )} > ɛ then decide H 1 , else decide H 0$$

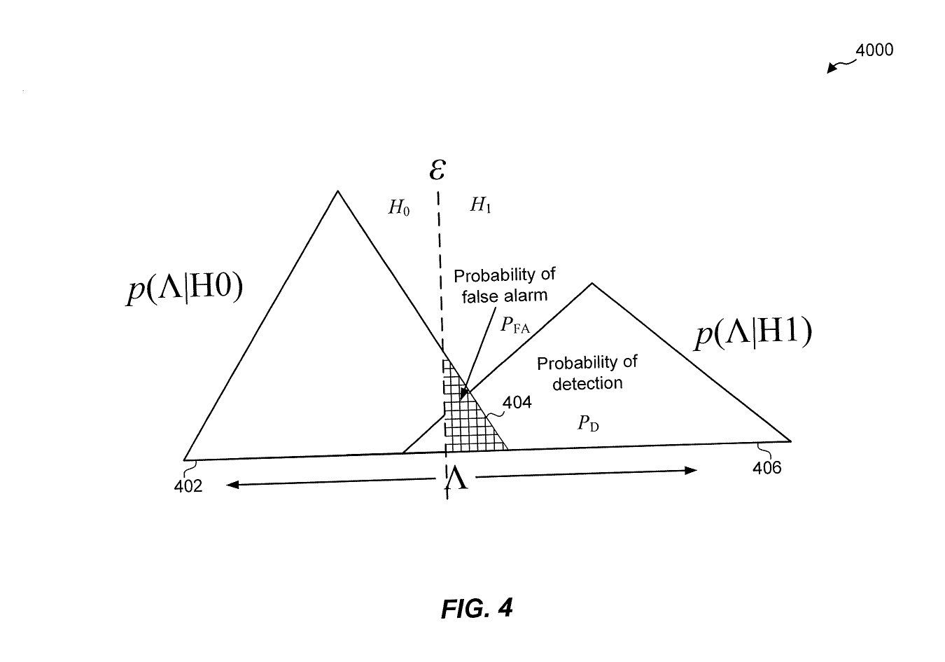

FIG. 4 illustrates an example of decision rule areas 4000 corresponding to the two hypothesis H0 and H1 in the likelihood ratio Λ. Accordingly, a log likelihood ratio in the present aspects assuming independent identically distributed (i.i.d) Gaussian noise may be determined as:

$$log ( p ( y \vert H 1 ) ) - log ( p ( y \vert H 0 ) ) = - {( y - {M}_{11} {x}_{11} - {I}_{11} )}^{H} ( y - {M}_{11} {x}_{11} - {I}_{11} ) / {σ}^{2} + {( y - {M}_{11} b - {I}_{11} )}^{H} ( y - {M}_{11} b - {I}_{11} ) / {σ}^{2}$$

In this generalized likelihood ratio, the parameters may be replaced by their respective estimated quantities available from the channel estimation prior to cleaning. As such, the decision metric and the decision rule executed by hypothesis testing component 1030 are:

Λ=(y−M₁\hat{b}− [symbol] ₁₁)^{H}(y−M₁\hat{b}− [symbol] ₁₁)−(y−M₁ [symbol] ₁₁− [symbol] ₁₁)^{H}(y−M₁ [symbol] ₁₁− [symbol] ₁₁)

Λ>log(ε)=0 then H1 else H0

In some aspects, hypothesis testing component 1030 may also define an erasure region based on this generalized likelihood ratio.

In some present aspects, TD-SCDMA channel estimation component 1006 may consider various decision metrics for cleaning such as either one of, or a combination of, the power of uncleaned channel tap estimates and the time correlation of channel tap estimates. For example, in one aspect, TD-SCDMA channel estimation component 1006 may compute the product of the power of uncleaned channel tap estimates and the time correlation of channel tap estimates, and use it as the cleaning metric. For example, in this aspect, TD-SCDMA channel estimation component 1006 may declare a tap as a signal tap if the product of the power of the uncleaned channel tap estimate (from the least squares results) and the time correlation of channel tap estimate is greater than a threshold.

In some aspects, TD-SCDMA channel estimation component 1006 may include combining logic component 1032 that uses a hybrid logic for cleaning by combining two or more cleaning methods, e.g., two or more of the cleaning methods described herein. In one aspect, for example, live taps may be identified based on hypothesis testing as described herein, and the power quantities may be time filtered (e.g., in the same manner in which the tap correlation Rₕ(i,n) is obtained as described herein with respect to the operation of temporal correlation component 1028, but with the term Rₕ(i,n) replaced with the power of the tap ID with tap index i at time index n: Pₕ(i,n)), followed by scaling the live taps with tap-wise MMSE and using pulse de-convolution to use odd-even correlation. In some aspects, for example, pulse de-convolution removes the pulse shaping component from the estimate of the channel to obtain a true wireless channel estimate. Accordingly, in these aspects, performing pulse de-convolution improves the identification of the channel, and hence improves the performance.

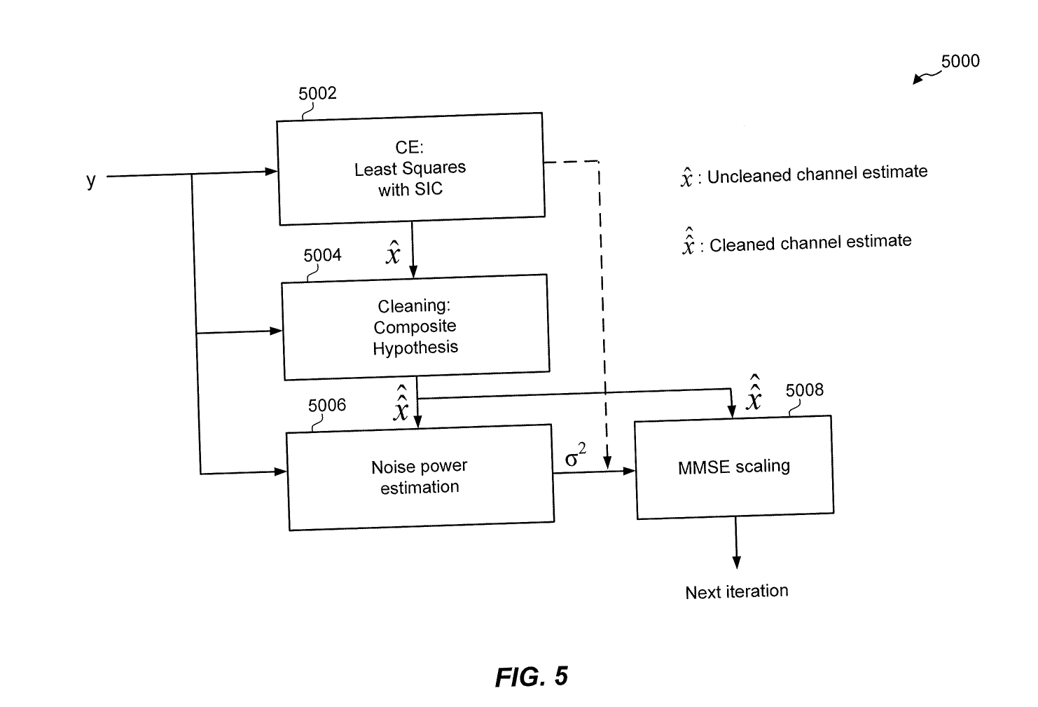

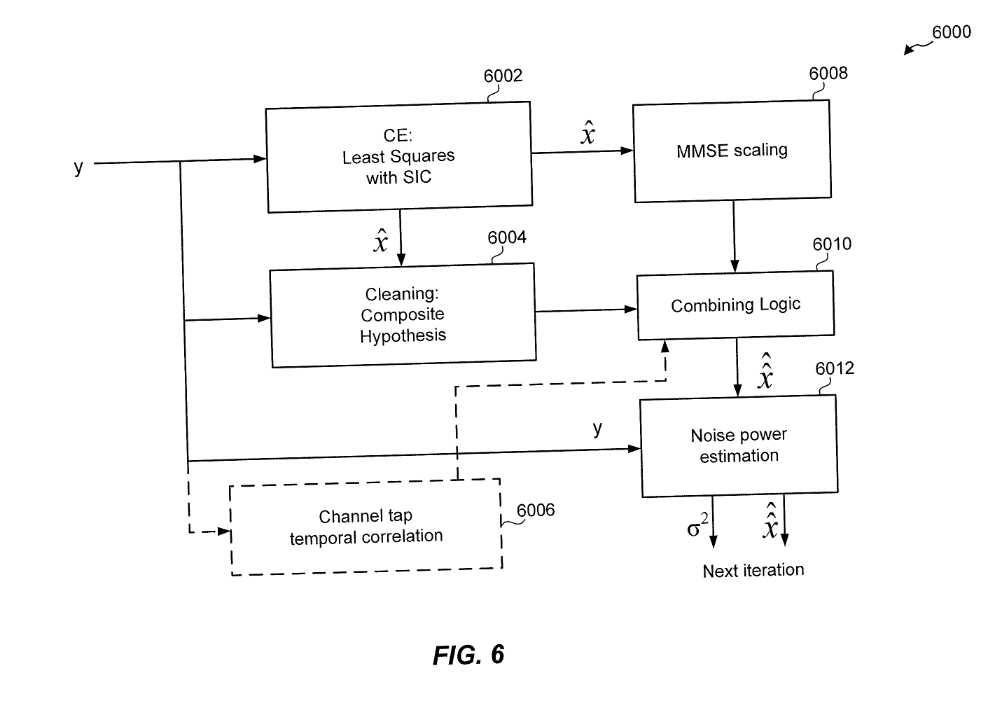

FIGS. 5 and 6 illustrate various example aspects of cleaning using hybrid logics that may be executed by TD-SCDMA channel estimation component 1006 of UE 1006. In FIG. 5, a second channel estimation method 5000 is illustrated that is based on hypothesis testing. The second channel estimation method 5000 includes least squares with SIC 5002 that is performed by least squares component 1020 on the received signal y to obtain uncleaned channel estimates. Then, composite hypothesis testing 5004 as described herein with respect to FIG. 4 is performed by hypothesis testing component 1030 based on the received signal and the uncleaned channel estimates to identify live taps. Based on the identified taps and the received signal, noise power estimation 5006 is performed by noise power determination component 1018. For example, in some aspects, noise power is computed as the variance of the difference between the received signal and the reconstructed signal:

$${σ}^{2} = var ( y - {\sum }_{i}^{ } {M}_{i} {h}_{i} )$$

Finally, MMSE scaling 5008 is performed by MMSE scaling component 1022 based on the identified taps and the estimated noise powers as described herein with respect to, for example, FIG. 2. Optionally, MMSE scaling 5008 may be performed by MMSE scaling component 1022 based on the identified taps and the estimated noise powers and further based on the uncleaned channel estimates from the results of the least squares 5002. For example, in an aspect, MMSE scaling 5008 may be performed on the identified taps from composite hypothesis testing 5004 and also on the uncleaned channel estimates from least squares with SIC 5002. Then, a tap is declared as zero (e.g., absent) when such tap is found to be zero in the MMSE scaling that is performed on the identified taps and also in the MMSE scaling that is performed on the uncleaned channel estimates.

FIG. 6 illustrates a third channel estimation method 6000 that is based on hypothesis testing. In the third channel estimation method 6000, least squares with SIC 6002 is performed by least squares component 1020 on the received signal y to obtain uncleaned channel estimates. Then, composite hypothesis testing 6004 as described herein with respect to FIG. 4 is performed by hypothesis testing component 1030 based on the received signal and the uncleaned channel estimates to identify live taps, and MMSE scaling 6008 is performed MMSE scaling component 1022 based on the uncleaned channel estimates, e.g., the output of the least squares channel estimation 6002 is used as input for MMSE scaling 6008. Then, a combining logic 6010 is performed by combining logic component 1032 based on the output of the MMSE scaling 6008 and composite hypothesis testing 6004 to identify live taps. For example, in an aspect, combining logic 6010 declares that a tap is zero (e.g., absent) when such tap is found to be zero in both MMSE scaling 6008 and composite hypothesis testing 6004. Optionally, in the third channel estimation method 6000, temporal correlation component 1028 may identify channel taps based on temporal correlation 6006, and combining logic component 1032 may further receive the results of the temporal correlation 6006 and combine them with the output of the MMSE scaling 6008 and composite hypothesis testing 6004 to identify live taps. For example, in one non-limiting aspect, combining logic 6010 may declare that a tap is present if such tap is identified as being present in all inputs of combining logic 6010 (e.g., in all of temporal correlation 6006, MMSE scaling 6008, and composite hypothesis testing 6004). In another non-limiting aspect, for example, combining logic 6010 may declare that a tap is present if such tap is identified as being present in a subset of the inputs of combining logic 6010 (e.g., the tap is identified as being present in the majority of the inputs, for example, in at least two out of three of temporal correlation 6006, MMSE scaling 6008, and composite hypothesis testing 6004). Finally, noise power estimation 6012 may be performed by noise power determination component 1018 based on the received signal y and the output of the combining logic 6010, e.g., as described herein with respect to noise power estimation 5006 in FIG. 5.

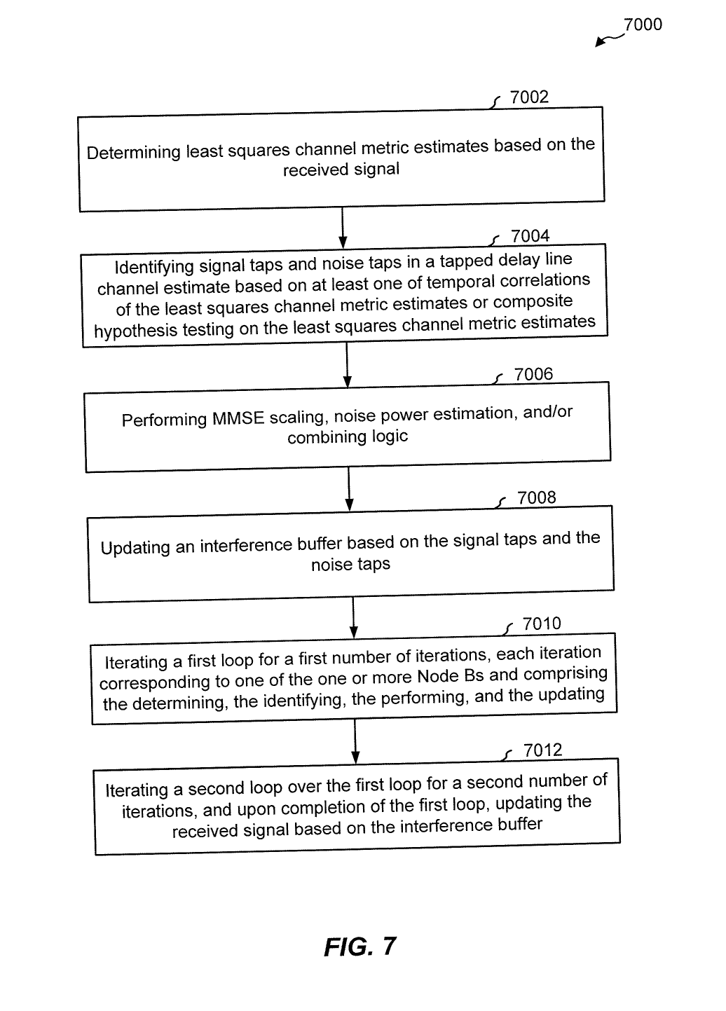

Referring to FIG. 7, in some aspects, method 7000 for enhanced channel estimation is illustrated. For explanatory purposes, method 7000 will be discussed with reference to the above described FIG. 1. It should be understood that in other implementations, other systems and/or UEs, Node Bs, or other apparatus comprising different components than those illustrated in FIG. 1 may be used when implementing method 7000 of FIG. 7.

At block 7002, method 7000 includes determining least squares channel metric estimates based on the received signal. For example, in an aspect, least squares component 1020 of TD-SCDMA channel estimation component 1006 may determine least squares channel metric estimates based on signals received from Node Bs 1004.

At block 7004, method 7000 includes identifying signal taps and noise taps in a tapped delay line channel estimate based on at least one of temporal correlations of the least squares channel metric estimates or composite hypothesis testing on the least squares channel metric estimates. For example, in an aspect, TD-SCDMA channel estimation component 1006 may determine signal taps 1010 and noise taps 1012 in channel estimate tapped delay line 1008 based on temporal correlations of the least squares channel metric estimates obtained by temporal correlation component 1028 or composite hypothesis testing on the least squares channel metric estimates performed by hypothesis testing component 1030.

For example, in some aspects, where TD-SCDMA channel estimation component 1006 determines signal taps 1010 and noise taps 1012 in channel estimate tapped delay line 1008 based on temporal correlations of the least squares channel metric estimates, temporal correlation component 1028 may determine a first set of taps based on the temporal correlations of the least squares channel metric estimates, and tap-wise MMSE component 1026 may determine a second set of taps that comprises tap-wise MMSE taps based on the least squares channel metric estimates. In these aspects, TD-SCDMA channel estimation component 1006 may declare a tap as a signal tap when a first tap value of the tap in the first set and a second tap value of the tap in the second set are equal.

In some alternative or additional aspects, for example, where TD-SCDMA channel estimation component 1006 determines signal taps 1010 and noise taps 1012 in channel estimate tapped delay line 1008 based on composite hypothesis testing on the least squares channel metric estimates, for each tap in the channel estimate tapped delay line 1008, composite hypothesis testing is performed by hypothesis testing component 1030 based on a likelihood ratio test between a first hypothesis and a second hypothesis, where the first hypothesis corresponds to a presence of the tap and the second hypothesis corresponds to an absence of the tap. In some aspects, for example, the first hypothesis and the second hypothesis are defined over a successive ordered composite hypothesis testing model for tap identification, and the successive ordered composite hypothesis testing model includes a target channel modeling stage and a target tap modeling. Further, in some aspects, the successive ordered composite hypothesis testing model is confined to a target midamble subspace. In some aspects, hypothesis testing component 1030 performs the composite hypothesis testing further based on the received signal to determine the signal taps and the noise taps, e.g., as described herein with reference to FIG. 5.

At block 7006, method 7000 includes performing minimum mean square error (MMSE) scaling, noise power estimation, and/or a combining logic. For example, in an aspect, MMSE scaling component 1022 may perform MMSE scaling on the signal taps and the noise taps. In some alternative or additional aspects, noise power determination component 1018 may determine a noise power estimate based on the received signal, the signal taps, and the noise taps. In some alternative or additional aspects, MMSE scaling component 1022 may perform MMSE scaling on the signal taps and the noise taps based on at least one of the noise power estimate from noise power determination component 1018 and the least squares channel estimates from least squares component 1020. For example, in some alternative or additional aspects, MMSE scaling component 1022 may perform MMSE scaling on the least squares channel metric estimates from least squares component 1020 to obtain scaled channel metric estimates.

In some alternative or additional aspects, combining logic component 1032 may perform a combining logic on scaled channel metric estimates from MMSE scaling component 1022, the signal taps, and the noise taps, to obtain a combined set of taps. Further, in these aspects, noise power determination component 1018 may determine a noise power estimate based on the received signal and the combined set of taps. In some alternative or additional aspects, combining logic component 1032 may obtain the combined set of taps further based on a set of taps determined based on the temporal correlations of the received signals by temporal correlation component 1028.

At block 7008, method 7000 includes updating an interference buffer based on the signal taps and the noise taps. For example, in some aspects, interference buffer updating component 1024 may update an interference buffer which holds the most recent estimates of the channels for the cells or Node Bs 1004, based on signal taps 1010 and noise taps 1012 that are determined at blocks 7004 and 7006.

At block 7010, method 7000 includes iterating a first loop for a first number of iterations, each iteration corresponding to one of the one or more Node Bs and comprising the determining, the identifying, the performing, and the updating. For example, in an aspect, inner loop iteration component 1014 may iterate an inner loop over cells or Node Bs 1004 by repeating blocks 7002, 7004, 7006, and 7008.

At block 7012, method 7000 includes iterating a second loop over the first loop for a second number of iterations, where the second loop includes, upon completion of the first loop, updating the received signal based on the interference buffer. For example, in an aspect, outer loop iteration component 1016 may iterate an outer loop by updating the received signal based on the updated interference buffer from block 7008 and then iterating over the inner loop at block 7010.

Accordingly, some present aspects provide improved channel estimation in TD-SCDMA by determining temporal correlations of the taps and/or performing composite hypothesis testing on the taps. Some alternative or additional aspects further improve channel estimation in TD-SCDMA by performing a combining logic to combine one or more of power time-filtering, ordered composite hypothesis testing, channel tap temporal correlation, or pulse de-convolution.

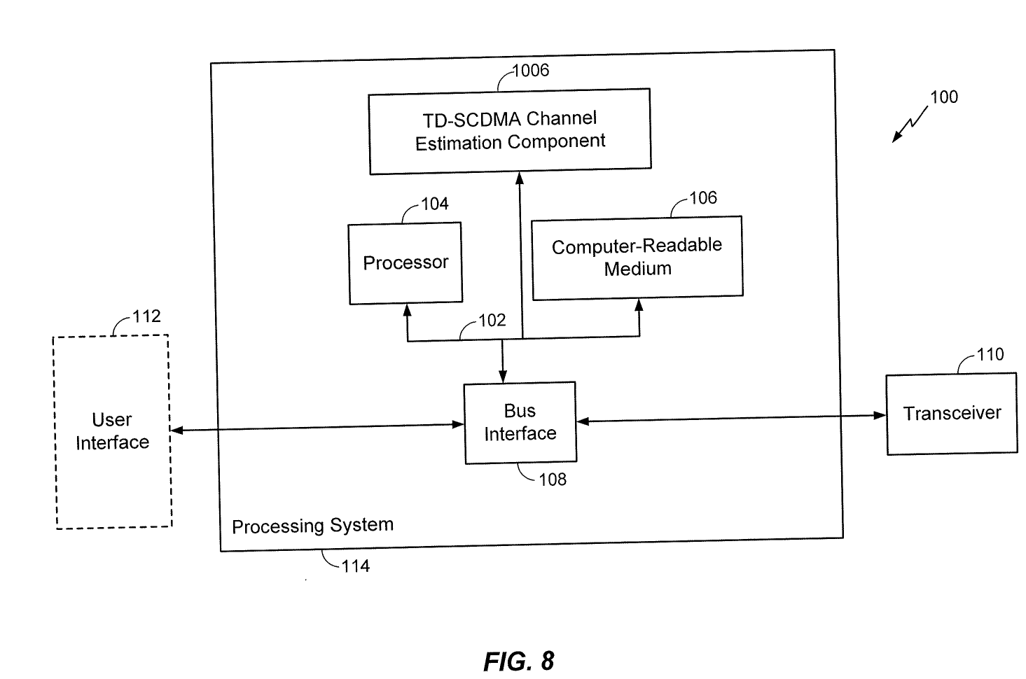

FIG. 8 is a block diagram illustrating an example of a hardware implementation for an apparatus 100 employing a processing system 114 to operate, for example, UE 1002, TD-SCDMA channel estimation component 1006, and/or respective components thereof (see FIG. 1). In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided. Apparatus 100 further includes TD-SCDMA channel estimation component 1006 (see FIG. 1) that is linked by bus 102 to other components of apparatus 100.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

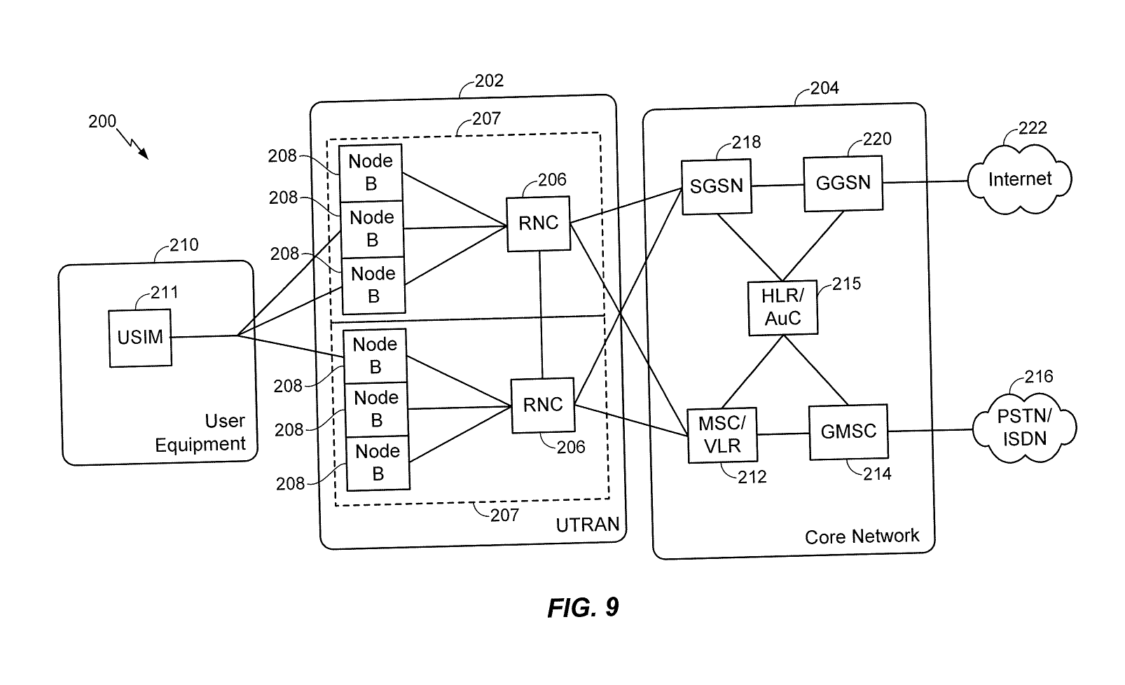

The various concepts presented throughout this disclosure may be implemented across a broad variety of telecommunication systems, network architectures, and communication standards. By way of example and without limitation, the aspects of the present disclosure illustrated in FIG. 9 are presented with reference to a UMTS system 200 employing a W-CDMA air interface. A UMTS network includes three interacting domains: a Core Network (CN) 204, a UMTS Terrestrial Radio Access Network (UTRAN) 202, and User Equipment (UE) 210. UE 210 or UTRAN 202 may include UE 1002, Node B 1004, TD-SCDMA channel estimation component 1006, or apparatus 100 (see FIGS. 1 and 8). In this example, the UTRAN 202 provides various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the RNCs 206 and RNSs 207 illustrated herein. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

Communication between a UE 210 and a Node B 208 may be considered as including a physical (PHY) layer and a medium access control (MAC) layer. Further, communication between a UE 210 and an RNC 206 by way of a respective Node B 208 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in the RRC Protocol Specification, 3GPP TS 25.331 v9.1.0, incorporated herein by reference.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a CN 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The DL, also called the forward link, refers to the communication link from a Node B 208 to a UE 210, and the UL, also called the reverse link, refers to the communication link from a UE 210 to a Node B 208.

The CN 204 interfaces with one or more access networks, such as the UTRAN 202. As shown, the CN 204 is a GSM core network. However, as those skilled in the art will recognize, the various concepts presented throughout this disclosure may be implemented in a RAN, or other suitable access network, to provide UEs with access to types of CNs other than GSM networks.

The CN 204 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a VLR that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The CN 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 210 provides feedback to the node B 208 over the HS-DPCCH to indicate whether it correctly decoded a packet on the downlink.

HS-DPCCH further includes feedback signaling from the UE 210 to assist the node B 208 in taking the right decision in teens of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the node B 208 and/or the UE 210 may have multiple antennas supporting MIMO technology. The use of MIMO technology enables the node B 208 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 210 to increase the data rate or to multiple UEs 210 to increase the overall system capacity. This is achieved by spatially precoding each data stream and then transmitting each spatially precoded stream through a different transmit antenna on the downlink. The spatially precoded data streams arrive at the UE(s) 210 with different spatial signatures, which enables each of the UE(s) 210 to recover the one or more the data streams destined for that UE 210. On the uplink, each UE 210 may transmit one or more spatially precoded data streams, which enables the node B 208 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

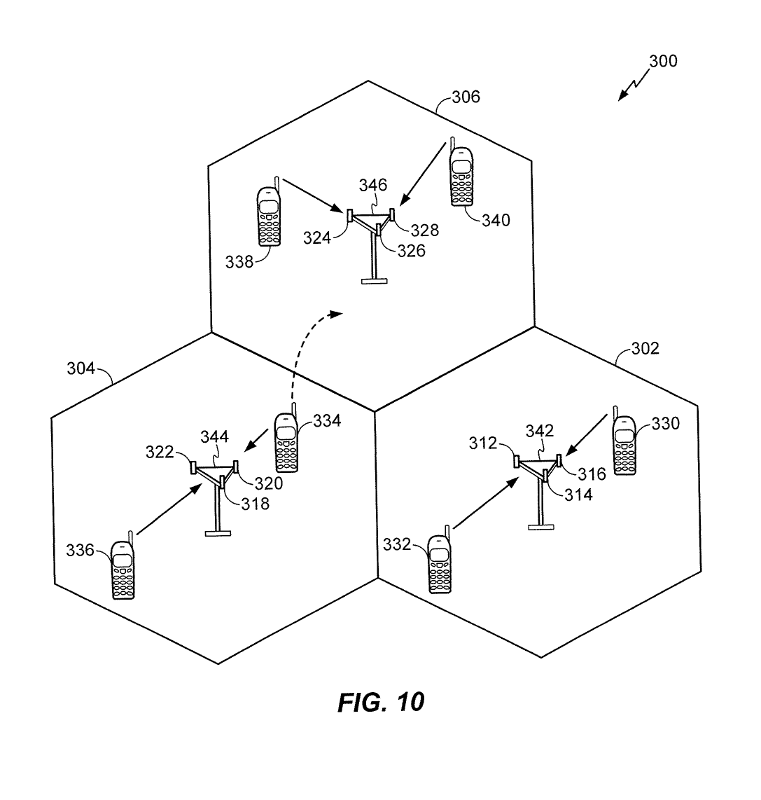

Referring to FIG. 10, an access network 300 in a UTRAN architecture is illustrated in which one or more of the wireless communication entities, e.g., UEs and/or base stations, may include UE 1002, 210, Node B 1004, 208, TD-SCDMA channel estimation component 1006, or apparatus 100 (see FIGS. 1, 8, and 9). The multiple access wireless communication system includes multiple cellular regions (cells), including cells 302, 304, and 306, each of which may include one or more sectors. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 may include several wireless communication devices, e.g., User Equipment or UEs, which may be in communication with one or more sectors of each cell 302, 304 or 306. For example, UEs 330 and 332 may be in communication with Node B 342, UEs 334 and 336 may be in communication with Node B 344, and UEs 338 and 340 can be in communication with Node B 346. Here, each Node B 342, 344, 346 is configured to provide an access point to a CN 204 (see FIG. 9) for all the UEs 330, 332, 334, 336, 338, 340 in the respective cells 302, 304, and 306.

As the UE 334 moves from the illustrated location in cell 304 into cell 306, a serving cell change (SCC) or handover may occur in which communication with the UE 334 transitions from the cell 304, which may be referred to as the source cell, to cell 306, which may be referred to as the target cell. Management of the handover procedure may take place at the UE 334, at the Node Bs corresponding to the respective cells, at a radio network controller 206 (see FIG. 9), or at another suitable node in the wireless network. For example, during a call with the source cell 304, or at any other time, the UE 334 may monitor various parameters of the source cell 304 as well as various parameters of neighboring cells such as cells 306 and 302. Further, depending on the quality of these parameters, the UE 334 may maintain communication with one or more of the neighboring cells. During this time, the UE 334 may maintain an Active Set, that is, a list of cells that the UE 334 is simultaneously connected to (i.e., the UTRA cells that are currently assigning a downlink dedicated physical channel DPCH or fractional downlink dedicated physical channel F-DPCH to the UE 334 may constitute the Active Set).

The modulation and multiple access scheme employed by the access network 300 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

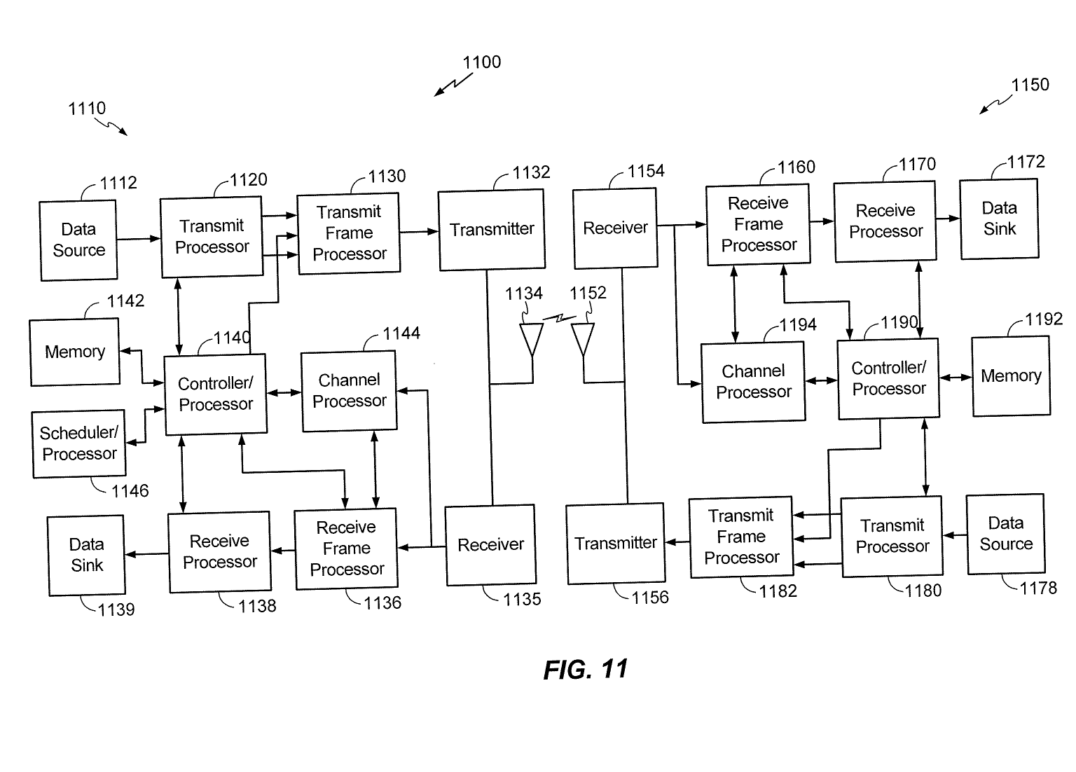

FIG. 11 is a block diagram of a Node B 1110 in communication with a UE 1150, where the Node B 1110 or the UE 1150 may include UE 1002, 210, Node B 1004, 208, TD-SCDMA channel estimation component 1006, or apparatus 100 (see, e.g., FIGS. 1, 8, and 9). In the downlink communication, a transmit processor 1120 may receive data from a data source 1112 and control signals from a controller/processor 1140. The transmit processor 1120 provides various signal processing functions for the data and control signals, as well as reference signals (e.g., pilot signals). For example, the transmit processor 1120 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 1144 may be used by a controller/processor 1140 to determine the coding, modulation, spreading, and/or scrambling schemes for the transmit processor 1120. These channel estimates may be derived from a reference signal transmitted by the UE 1150 or from feedback from the UE 1150. The symbols generated by the transmit processor 1120 are provided to a transmit frame processor 1130 to create a frame structure. The transmit frame processor 1130 creates this frame structure by multiplexing the symbols with information from the controller/processor 1140, resulting in a series of frames. The frames are then provided to a transmitter 1132, which provides various signal conditioning functions including amplifying, filtering, and modulating the frames onto a carrier for downlink transmission over the wireless medium through antenna 1134. The antenna 1134 may include one or more antennas, for example, including beam steering bidirectional adaptive antenna arrays or other similar beam technologies.

At the UE 1150, a receiver 1154 receives the downlink transmission through an antenna 1152 and processes the transmission to recover the information modulated onto the carrier. The information recovered by the receiver 1154 is provided to a receive frame processor 1160, which parses each frame, and provides information from the frames to a channel processor 1194 and the data, control, and reference signals to a receive processor 1170. The receive processor 1170 then performs the inverse of the processing performed by the transmit processor 1120 in the Node B 1110. More specifically, the receive processor 1170 descrambles and despreads the symbols, and then determines the most likely signal constellation points transmitted by the Node B 1110 based on the modulation scheme. These soft decisions may be based on channel estimates computed by the channel processor 1194. The soft decisions are then decoded and deinterleaved to recover the data, control, and reference signals. The CRC codes are then checked to determine whether the frames were successfully decoded. The data carried by the successfully decoded frames will then be provided to a data sink 1172, which represents applications running in the UE 1150 and/or various user interfaces (e.g., display). Control signals carried by successfully decoded frames will be provided to a controller/processor 1190. When frames are unsuccessfully decoded by the receiver processor 1170, the controller/processor 1190 may also use an acknowledgement (ACK) and/or negative acknowledgement (NACK) protocol to support retransmission requests for those frames.

In the uplink, data from a data source 1178 and control signals from the controller/processor 1190 are provided to a transmit processor 1180. The data source 1178 may represent applications running in the UE 1150 and various user interfaces (e.g., keyboard). Similar to the functionality described in connection with the downlink transmission by the Node B 1110, the transmit processor 1180 provides various signal processing functions including CRC codes, coding and interleaving to facilitate FEC, mapping to signal constellations, spreading with OVSFs, and scrambling to produce a series of symbols. Channel estimates, derived by the channel processor 1194 from a reference signal transmitted by the Node B 1110 or from feedback contained in the midamble transmitted by the Node B 1110, may be used to select the appropriate coding, modulation, spreading, and/or scrambling schemes. The symbols produced by the transmit processor 1180 will be provided to a transmit frame processor 1182 to create a frame structure. The transmit frame processor 1182 creates this frame structure by multiplexing the symbols with information from the controller/processor 1190, resulting in a series of frames. The frames are then provided to a transmitter 1156, which provides various signal conditioning functions including amplification, filtering, and modulating the frames onto a carrier for uplink transmission over the wireless medium through the antenna 1152.

The uplink transmission is processed at the Node B 1110 in a manner similar to that described in connection with the receiver function at the UE 1150. A receiver 1135 receives the uplink transmission through the antenna 1134 and processes the transmission to recover the information modulated onto the carrier. The information recovered by the receiver 1135 is provided to a receive frame processor 1136, which parses each frame, and provides information from the frames to the channel processor 1144 and the data, control, and reference signals to a receive processor 1138. The receive processor 1138 performs the inverse of the processing performed by the transmit processor 1180 in the UE 1150. The data and control signals carried by the successfully decoded frames may then be provided to a data sink 1139 and the controller/processor, respectively. If some of the frames were unsuccessfully decoded by the receive processor, the controller/processor 1140 may also use an acknowledgement (ACK) and/or negative acknowledgement (NACK) protocol to support retransmission requests for those frames.

The controllers/processors 1140 and 1190 may be used to direct the operation at the Node B 1110 and the UE 1150, respectively. For example, the controller/processors 1140 and 1190 may provide various functions including timing, peripheral interfaces, voltage regulation, power management, and other control functions. The computer readable media of memories 1142 and 1192 may store data and software for the Node B 1110 and the UE 1150, respectively. A scheduler/processor 1146 at the Node B 1110 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. A method for channel estimation in time division synchronous code division multiple access (TD-SCDMA) based on a signal received from one or more Node Bs, comprising:
determining least squares channel metric estimates based on the received signal;
identifying taps in a tapped delay line channel estimate as signal taps or noise taps based on temporal correlations of the least squares channel metric estimates and composite hypothesis testing on the least squares channel metric estimates; and
updating an interference buffer based on the signal taps and the noise taps.

2. The method of claim 1, further comprising:
performing minimum mean square error scaling on the signal taps and the noise taps; and
iterating a first loop for a first number of iterations, each iteration corresponding to one of the one or more Node Bs and comprising the determining, the identifying, the performing, and the updating.

3. The method of claim 2, further comprising:
iterating a second loop over the first loop for a second number of iterations, the second loop comprising:
upon completion of the first loop, updating the received signal based on the interference buffer.

4. The method of claim 1, wherein the identifying comprises:
determining a first set of taps based on the temporal correlations of the least squares channel metric estimates;
determining a second set of taps that comprises tap-wise minimum mean squared estimate taps based on the least squares channel metric estimates; and
declaring one of the taps in the tapped delay line channel estimate as a signal tap when a first tap value of the one tap in the first set and a second tap value of the one tap in the second set are equal.

5. The method of claim 1, wherein, for each tap in the tapped delay line channel estimate, the composite hypothesis testing is based on a likelihood ratio test between a first hypothesis and a second hypothesis, wherein the first hypothesis corresponds to a presence of the tap and the second hypothesis corresponds to an absence of the tap.

6. The method of claim 5, wherein the first hypothesis and the second hypothesis are defined over a successive ordered composite hypothesis testing model for tap identification, wherein the successive ordered composite hypothesis testing model includes a target channel modeling stage and a target tap modeling.

7. The method of claim 6, wherein the successive ordered composite hypothesis testing model is confined to a target midamble subspace.

8. The method of claim 1, wherein the composite hypothesis testing is further based on the received signal, the method further comprising:
determining a noise power estimate based on the received signal, the signal taps, and the noise taps.

9. The method of claim 8, further comprising:
performing minimum mean square error scaling on the signal taps and the noise taps based on at least one of the noise power estimate and the least squares channel estimates.

10. The method of claim 1, wherein the composite hypothesis testing is further based on the received signal, the method further comprising:
performing minimum mean square error scaling on the least squares channel metric estimates to obtain scaled channel metric estimates;
performing a combining logic on the scaled channel metric estimates, the signal taps, and the noise taps, to obtain a combined set of taps; and
determining a noise power estimate based on the received signal and the combined set of taps.

11. The method of claim 10, further comprising:
determining a set of taps based on the temporal correlations of the received signals, wherein the combining logic obtains the combined set of taps further based on the set of taps.

12. An apparatus for channel estimation in time division synchronous code division multiple access (TD-SCDMA) based on a signal received from one or more Node Bs, comprising:
a processing system configured to:
determine least squares channel metric estimates based on the received signal;
identify taps in a tapped delay line channel estimate as signal taps or noise taps based on temporal correlations of the least squares channel metric estimates and composite hypothesis testing on the least squares channel metric estimates; and
update an interference buffer based on the signal taps and the noise taps.

13. The apparatus of claim 12, wherein the processing system is further configured to:
perform minimum mean square error scaling on the signal taps and the noise taps; and
iterate a first loop for a first number of iterations, each iteration corresponding to one of the one or more Node Bs and comprising the determining, the identifying, the performing, and the updating.

14. The apparatus of claim 12, wherein the processing system is further configured to:
iterate a second loop over the first loop for a second number of iterations, the second loop comprising:
upon completion of the first loop, updating the received signal based on the interference buffer.

15. The apparatus of claim 12, wherein the processor is configured to identify the signal taps and the noise taps by:
determining a first set of taps based on the temporal correlations of the least squares channel metric estimates;
determining a second set of taps that comprises tap-wise minimum mean squared estimate taps based on the least squares channel metric estimates; and
declaring one of the taps in the tapped delay line channel estimate as a signal tap when a first tap value of the one tap in the first set and a second tap value of the tap in the second set are equal.

16. The apparatus of claim 12, wherein, for each tap in the tapped delay line channel estimate, the composite hypothesis testing is based on a likelihood ratio test between a first hypothesis and a second hypothesis, wherein the first hypothesis corresponds to a presence of the tap and the second hypothesis corresponds to an absence of the tap.

17. The apparatus of claim 16, wherein the first hypothesis and the second hypothesis are defined over a successive ordered composite hypothesis testing model for tap identification, wherein the successive ordered composite hypothesis testing model includes a target channel modeling stage and a target tap modeling and is confined to a target midamble subspace.

18. The apparatus of claim 12, wherein the composite hypothesis testing is further based on the received signal, wherein the processor is further configured to:
determine a noise power estimate based on the received signal, the signal taps, and the noise taps; and
performing minimum mean square error scaling on the signal taps and the noise taps based on at least one of the noise power estimate and the least squares channel estimates.

19. The apparatus of claim 12, wherein the composite hypothesis testing is further based on the received signal, wherein the processor is further configured to:
perform minimum mean square error scaling on the least squares channel metric estimates to obtain scaled channel metric estimates;
perform a combining logic on the scaled channel metric estimates, the signal taps, and the noise taps, to obtain a combined set of taps;
determine a noise power estimate based on the received signal and the combined set of taps; and
determine a set of taps based on the temporal correlations of the received signals, wherein the combining logic obtains the combined set of taps further based on the set of taps.

20. A non-transitory computer-readable medium storing executable code for channel estimation in time division synchronous code division multiple access (TD-SCDMA) based on a signal received from one or more Node Bs, comprising:
code for determining least squares channel metric estimates based on the received signal;
code for identifying taps in a tapped delay line channel estimate as signal taps or noise taps based on temporal correlations of the least squares channel metric estimates and composite hypothesis testing on the least squares channel metric estimates; and
code for updating an interference buffer based on the signal taps and the noise taps.
